(19) United States
(12) Patent Application Publication
(10) Pub. No.: US 2006/0007627 A1
(43) Pub. Date: Jan. 12, 2006

(54) Intelligent relay system

(76) Inventor: James M. Lewis, Moulton, AL (US)

Correspondence Address: WELSH & FLAXMAN LLC, 2000 DUKE STREET, SUITE 100, ALEXANDRIA, VA, 22314, US

(21) Appl. No.: 10/884,956

(22) Filed: Jul. 7, 2004

(51) Int. Cl. H01H 47/00

(52) U.S. Cl. 361/160

(57) ABSTRACT

An intelligent relay system quickly responds to a variety of influences. The relay system includes at least one relay, at least one peripheral sensor collecting data related to the relay system, and a control logic section linked to the relay and the sensor. The control logic section is further linked to a control computer via a communication interface. The control logic section includes means for intelligently controlling operation of the relay based upon instructions received from the control computer and data collected via the at least one peripheral sensor and the relay. The system is further adapted for use in a networked arrangement.

### BACKGROUND OF THE INVENTION

1. Field of the Invention

The invention relates to electronic relays. More particularly, the invention relates to an intelligent relay system for electronic switching assemblies

2. Description of the Prior Art

Advances in solid-state switching and relay technology have made possible the replacement of many electro-mechanical switching and relay assemblies. Solid-state devices provide the power control systems in which they are incorporated with long life, quiet operation and other associated advantages.

However, those skilled in the art will appreciate the difficulties associated with the development of electronic relays that may be used for AC power switching. Prior systems have exhibited shortcomings in the manner i which they provide for quick and reliable switching required in the management of AC power sources.

In addition to prior systems failing to provide for adequate switching required in the management of AC power sources, prior relays generally employ normally open contacts as opposed to the implementation of normally closed contacts. The use of normally open contacts results from the ready availability and ease of construction. Prior to the development of the present invention, the implementation of normally closed contacts in a solid-state relay would have required the inclusion of additional power inputs; something generally considered undesirable due to the added complexity and cost of the overall relay.

Further to the specific operation of solid-state relays, the prior art has yet to address the control of relays based upon a variety of external and internal criteria assessed by the relay itself. Current relays are commonly designed with a specific function in mind. However, unforeseen problems and situations often arise and these relays must either be reworked or replaced with relays better adapted to handle the unforeseen problems.

A need, therefore, continues to exist for a relay system overcoming the shortcomings of the prior art. In particular, a need exists for an intelligent relay system capable of readily responding to a variety of external and internal events confronting the relay. The present invention provides such an intelligent relay system, which achieves data collection, data management, decision capabilities, control, and information management in an efficient and reliable manner.

### SUMMARY OF THE INVENTION

It is an object of the present invention to provide an intelligent relay system adapted for quickly responding to a variety of influences. The relay system includes at least one relay, at least one peripheral sensor collecting data related to the relay system, and a control logic section linked to the relay and the sensor. The control logic section is further linked to a control computer via a communication interface. The control logic section includes means for intelligently controlling operation of the relay based upon instructions received from the control computer and data collected via the at least one peripheral sensor and the relay.

It is also an object of the present invention to provide a relay system network composed of a plurality of networked intelligent relay systems adapted for quickly responding to a variety of influences. Each of the relay systems includes at least one relay, at least one peripheral sensor collecting data related to the relay system, and a control logic section linked to the relay and the sensor. The control logic section is further linked to a control computer via a communication interface. The control logic section includes means for intelligently controlling operation of the relay based upon instructions received from the control computer and data collected via the at least one peripheral sensor and the relay.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is schematic of an intelligent relay system with external components in accordance with the present invention.

FIG. 2 is a schematic of an intelligent relay in accordance with the present invention.

FIG. 3 is a schematic of a triple-pole, double throw system in accordance with the present invention.

FIG. 4 is a schematic of a basic MOSFET switching circuit.

FIG. 5 is a schematic of the transformer system utilized in accordance with the present invention.

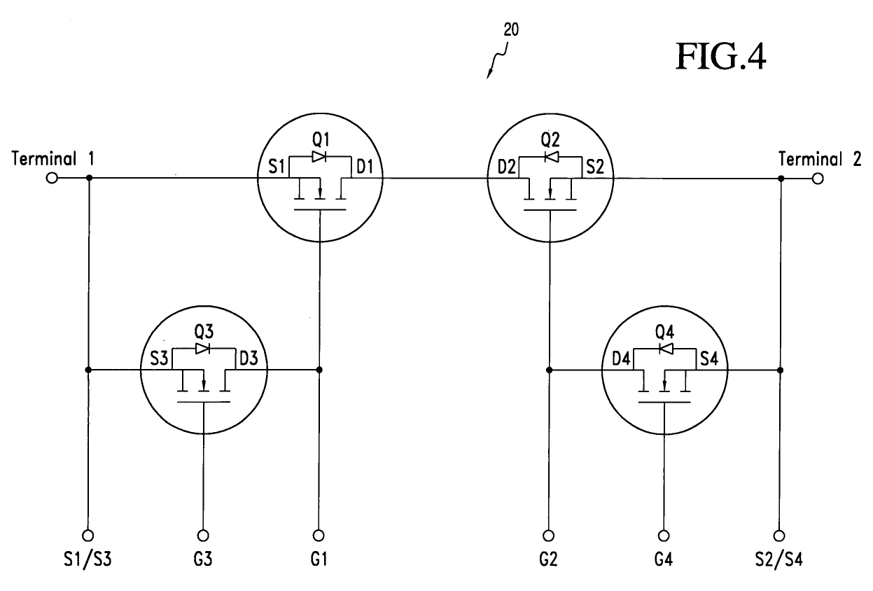

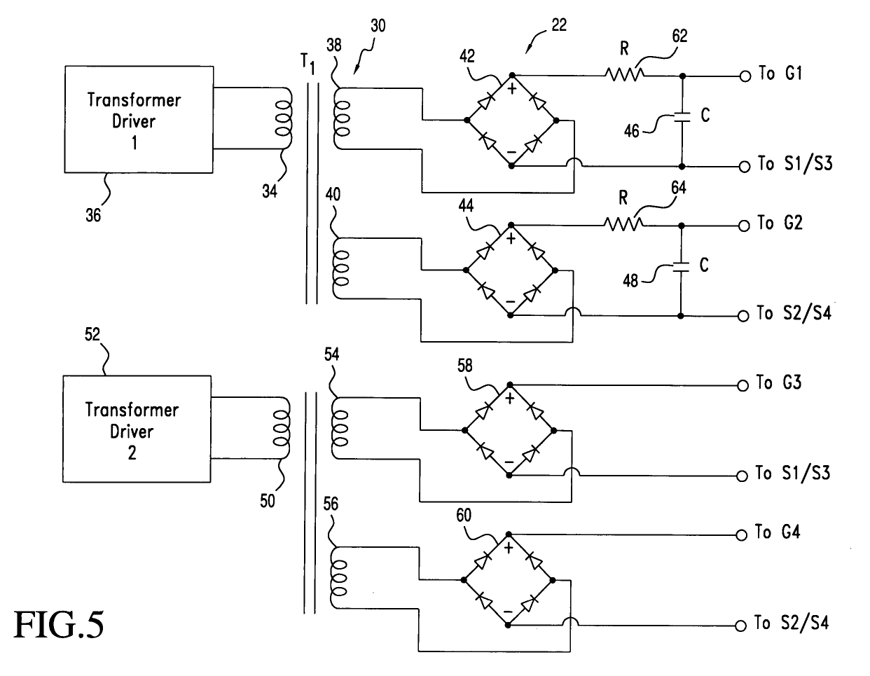

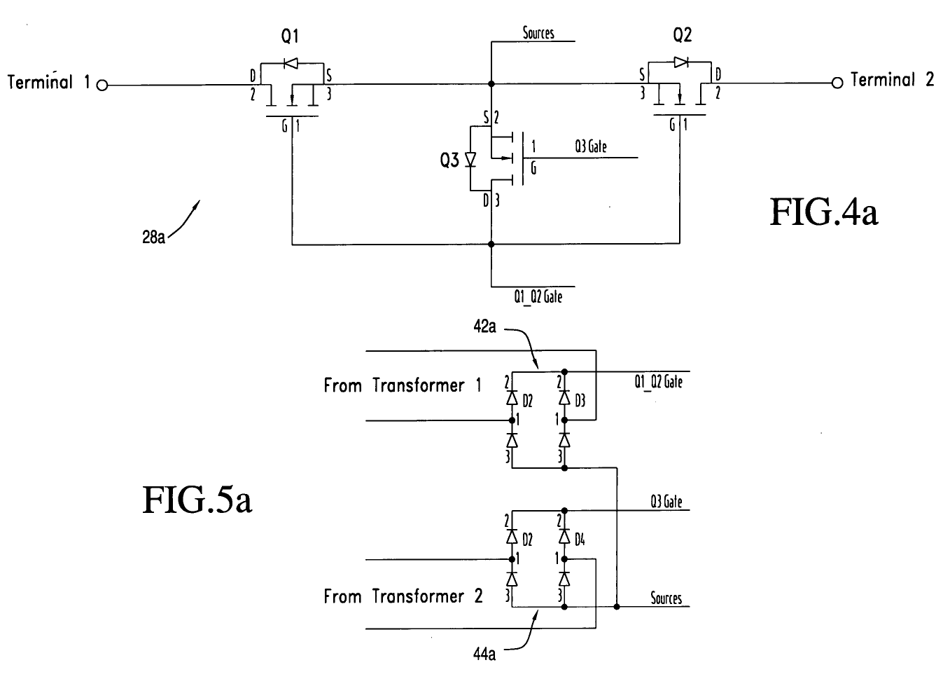

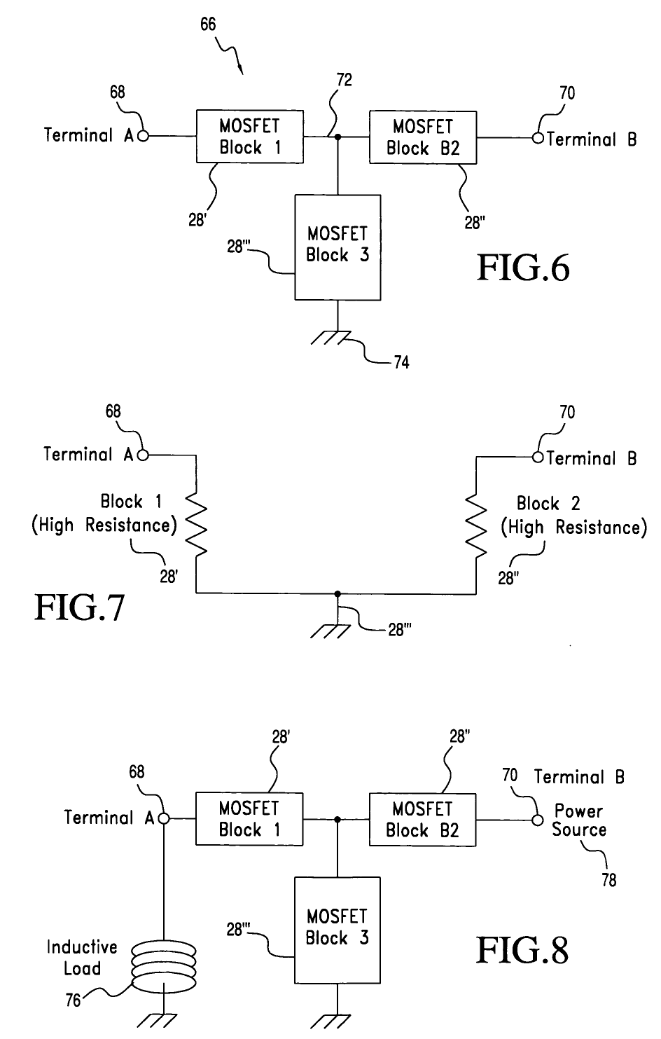

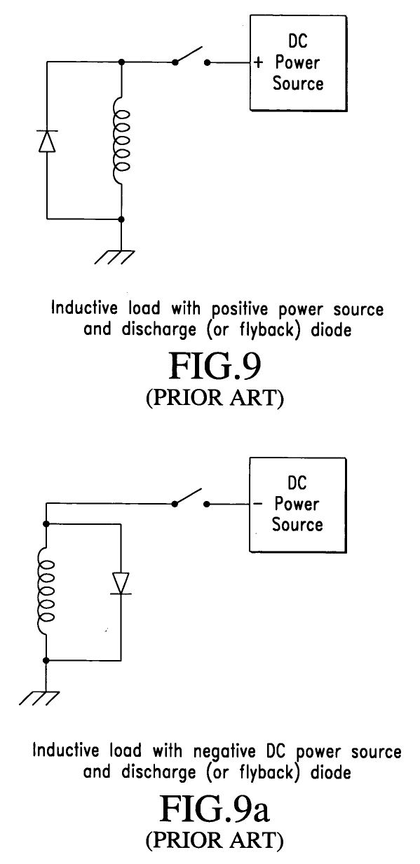

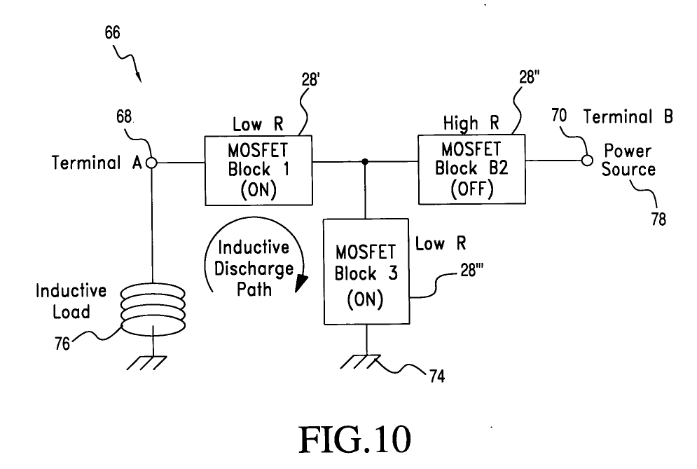

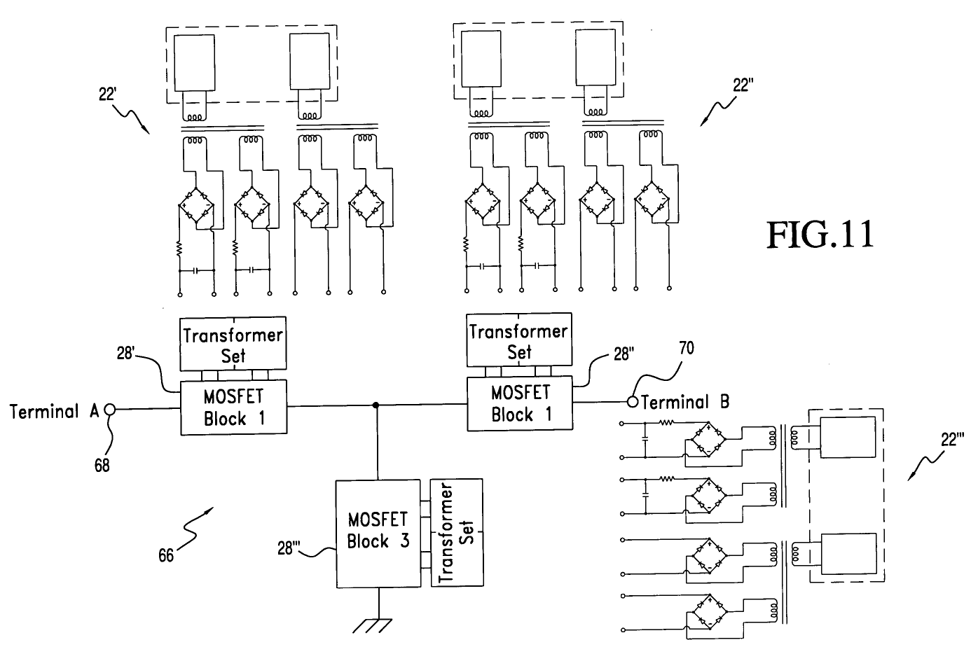

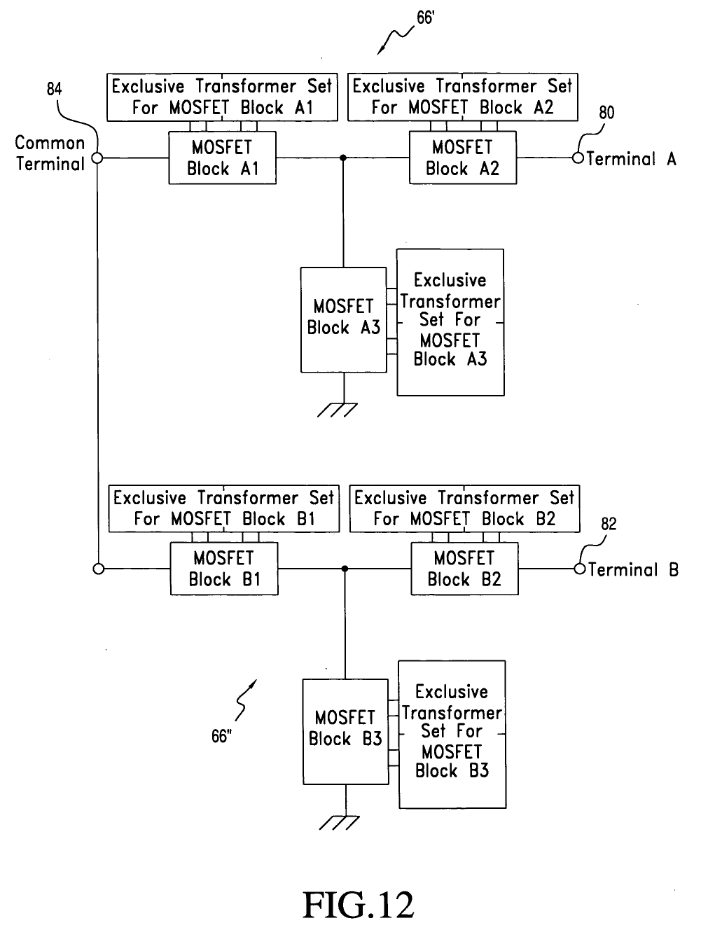

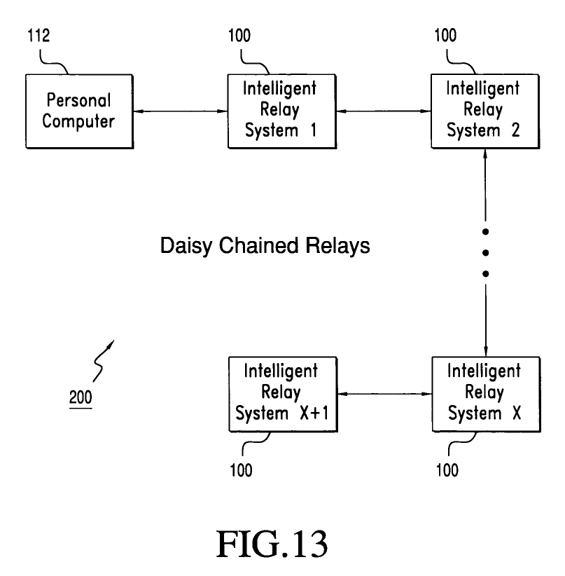

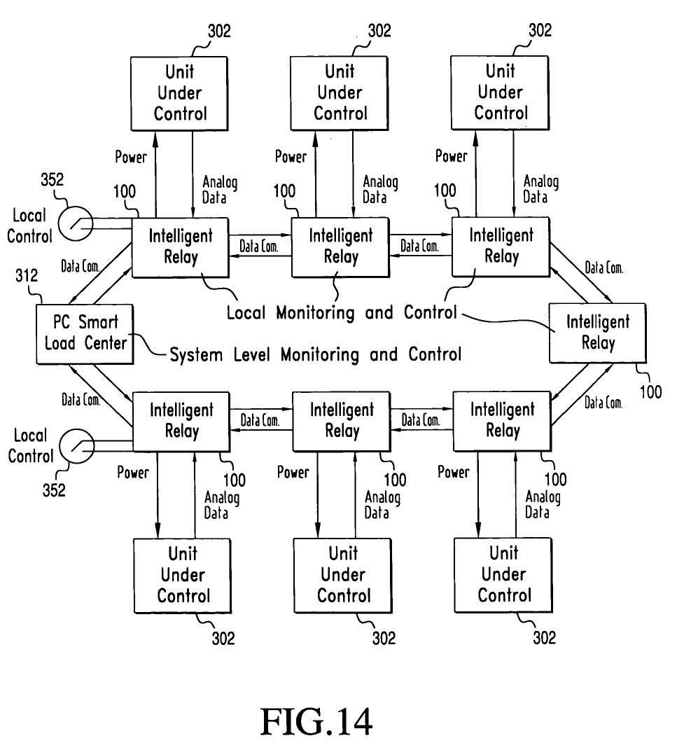

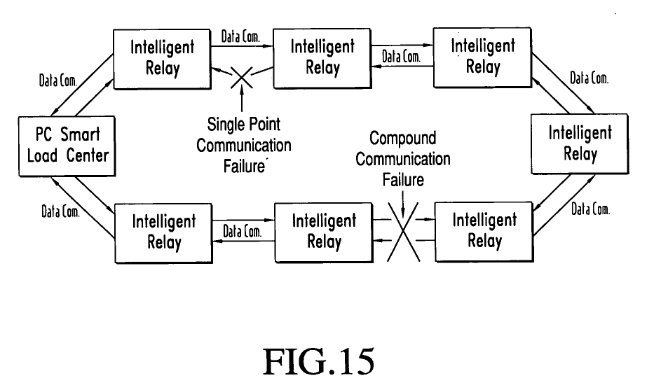

FIGS. 4a and 5a are respective schematics of an alternate switching circuit and transformer system.

FIG. 6 is a schematic of an AC relay block.

FIG. 7 is a schematic of the AC relay block in isolation mode.

FIG. 8 is a schematic of the AC relay block with an inductive load.

FIGS. 9 and 9a are schematics of prior art systems for disclosing the handling of inductive loads in combination with a DC power source.

FIG. 10 is a schematic showing the AC relay block when configured for inductive discharge.

FIG. 11 is a schematic of the AC relay block of FIG. 5 with transformers associated therewith.

FIG. 12 is a schematic of a double-throw system constructed with AC relay blocks.

FIG. 13 is a daisy chain topology employing intelligent relay systems in accordance with the present invention.

FIG. 14 is a schematic of a complete system in accordance with the present invention with redundant data flow connected to a personal computer that serves as a smart load center.

FIG. 15 is a schematic of a system in accordance with the present invention with multiple communication failures, but still capable of communication and control.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

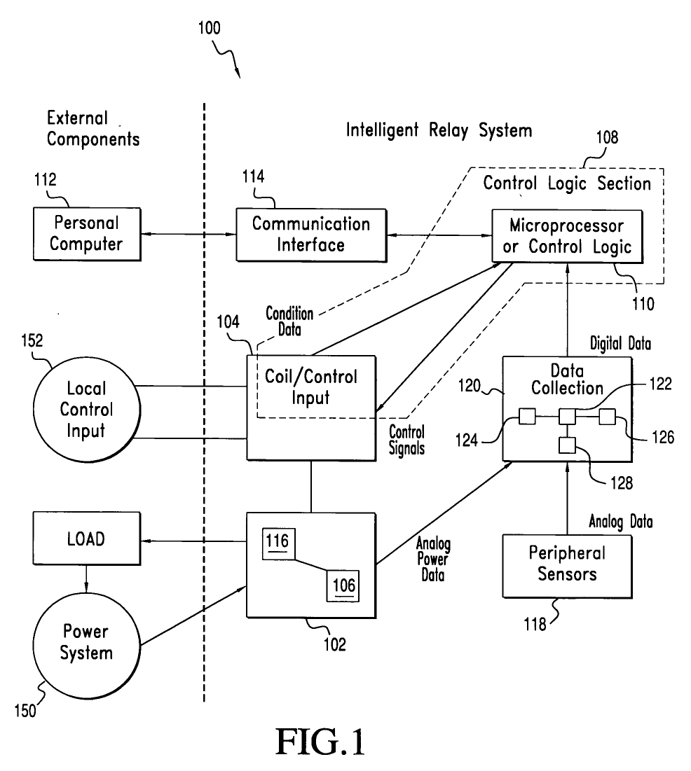

With reference to FIG. 1, a relay system 100 adapted for quickly responding to external and internal influences is disclosed. The relay system provides for data collection, data management, decision capabilities, control, and information management.

Briefly, and without entering into the details of the present system, data collection is achieved by providing a system for collecting power information and effectual information. Power information includes voltage, current and power factor (phase) information. Effectual information concerns the effects of power demands and results of deciding to use or not to use power. As simple example of the importance of effectual data is measuring the ambient temperature of a compartment to help determine if HVAC load can be reduced.

Data management is provided through the utilization of mechanisms for analyzing and storing data and methods for identifying trends, problems and anomalies. The present system allows for the comparison of data to previous data in an efficient manner and helps identify problems beyond the scope of simple power management. As for decision capabilities, the present invention provides for the ability to timely and efficiently make decisions. For example, these decisions may deal with power load assessments, power distribution and load sharing, and handling emergency situations.

Ultimately, decision capabilities may be divided into criteria based decisions and intelligence based decisions. Criteria base decisions are dictated by a system of rules for controlling power loads. This could include a system-by-system load assessment that will include rankings or prioritizing the loads in a system to determine the criticality of varying load demands. Once the criteria are established, the system can selectively turn loads off or on based on the criticality for a particular power demand scenario. Intelligence base decisions require a system capable of reacting to unexpected events. The present system provides for intelligence based decisions by recognizing trends and differentiating between normal and abnormal trends. This is accomplished by providing control software which performs a baseline sampling of normal operations to establish normal operating references for the decision making process. Operating conditions outside program or reference parameters are monitored through the implementation of new guidelines, or internal checks, for comparison purposes. If parameters exceed acceptable ranges, the system is able to trigger an alarm, flash a message on the control system of the present invention or shut down/scale back a load.

Control includes the ability to override power demand and make changes in real time in order to affect overall load requirements. For example, control may include the ability to adjust power factor to allow an inductive load (motor) to operator more efficiently or the ability to reduce or turn off lighting in unoccupied compartments.

As to information management, it includes display of system status, efficient communication of problems and unusual events, organizing and storing data, and providing access to system information. The information collected and stored can be used to develop trend analyses for loads, such as, motors, to determine if the motor is running at maximum efficiency. Vibration or thermal sensors on a motor, for example, could help predict premature bearing wear, which would result in a trend of increased motor temperature or vibration. Periodic reports could greatly assist maintenance crews by alerting them to system problems before major failures occur, saving time and resources. These reports could also be tied into preventative maintenance schedules by setting priorities to ailing systems.

The relay system 100 employs a variety of data gather and analysis tools employed in creating an “intelligent relay system”. In particular, the intelligent relay system 100 is adapted for use in conjunction with a MOSFET based, high voltage, high current AC electronic relay (but may be employed with an electromechanical contactor or relay. The intelligent relay system 100 provides for intelligent operation of the relay, ready communication with and/or alteration of the relay, and communication among coordinated relays.

The intelligent relay system 100 in accordance with a preferred embodiment includes at least a single relay 102. The present intelligent relay system 100 may be configured as a stand alone intelligent relay system in which a single relay functions without concern for the operation of other relays or a networked intelligent relay system in which a plurality of relays are linked for cooperative operation.

As mentioned above, the relays 102 employed in accordance with a preferred embodiment of the present invention are MOSFET based, high voltage, high current AC electronic relays including a transformer arrangement 116 as disclosed in prior U.S. patent application Ser. No. 10/684,408, filed Oct. 15, 2003, entitled “MOSFET BASED, HIGH VOLTAGE, ELECIRONIC RELAYS FOR AC POWER SWITCHING AND INDUCTIVE LOADS”, U.S. patent application Ser. No. 10/386,665, filed Mar. 13, 2003, entitled “MOSFET BASED, HIGH VOLTAGE, ELECIRONIC RELAYS FOR AC POWER SWITCHING AND INDUCTIVE LOADS” and U.S. patent application Ser. No. 10/034,925, filed Dec. 31, 2001, entitled “MOSFET BASED, HIGH VOLTAGE, ELECTRONIC RELAYS FOR AC POWER SWITCHING AND INDUCTIVE LOADS”, which is currently U.S. Pat. No. 6,683,393, which are incorporated herein by reference, and a switching assembly 106 equivalent to the MOSFET circuitry disclosed in prior U.S. patent application Ser. No. 10/684,408, filed Oct. 15, 2003, entitled “MOSFET BASED, HIGH VOLTAGE, ELECIRONIC RELAYS FOR AC POWER SWITCHING AND INDUCTIVE LOADS”, U.S. patent application Ser. No. 10/386,665, filed Mar. 13, 2003, entitled “MOSFET BASED, HIGH VOLTAGE, ELECTRONIC RELAYS FOR AC POWER SWITCHING AND INDUCTIVE LOADS” and U.S. patent application Ser. No. 10/034,925, filed Dec. 31, 2001, entitled “MOSFET BASED, HIGH VOLTAGE, ELECTRONIC RELAYS FOR AC POWER SWITCHING AND INDUCTIVE LOADS”, which is currently U.S. Pat. No. 6,683,393.

The intelligent relay system 100 further includes a control logic section 108 composed of a microprocessor/control logic 110, which is linked to a personal computer 112 via a communication interface 114, and the coil/control input 104. The microprocessor 110 of the control logic section 108 is integrally associated with the coil/control input 104, sharing many of the structural components making up the coil/control input 104. In addition, the communication interface 114 is preferably part of the microprocessor/control logic 110 (regardless of the form in which it is implemented). In accordance with a preferred embodiment of the present invention, the coil/control input 104 is not the decision making portion of the control logic section 108 and is not the “nuts and bolts” which actually turns the relay 102 on and off. Rather, the coil/control input 104 is the output that turns the transformers of the relay 102 on or off.

The control logic section 108 intelligently controls the operation of the coil/control input 104, and ultimately the switching assembly 106 based upon instructions received from the personal computer 112 and data collected via a peripheral sensor(s) 118, the switching assembly 106 and the coil/control input 104. The data collected from the peripheral sensor(s) 118, the switching assembly 106 and the coil/control input 104 may be converted in a data collection module including analog to digital (A/D) converters 122. In addition to providing for analog to digital conversion, and as will be discussed below in greater detail, the data collection module 120 includes analog signal conditioning (such as voltage dividers, amplifiers, and filters), optical isolators, and interface to peripheral sensors.

Besides collecting data necessary for electrical system control, the present system 100 is capable of collecting other data that may be useful for command decisions. For example, the present system 100 may be designed to collect external data, such as, but not limited to, load or compartment temperature, shock and vibration, humidity, air/fluid flow rates, fluid levels, speed/velocity/RPM, rotation/displacement/direction, and compartment occupancy.

The ability to measure and track equipment operational information provides for the possibility of predicting equipment failure and monitoring equipment aging. A simple example is monitoring the power requirements of a motor along with the motor output (RPM and torque). If the motor begins using more input power per unit of output power, such as, less RPM at constant torque per Watt of power consumed, a problem with the unit may be to blame. The speed at which the input/output functions indicates whether the system is simply aging or experiencing some type of failure.

More accurate maintenance recommendations become possible as data is collected on multiple pieces of equipment over a long period of performance and under varying operating conditions, allowing more detailed analysis of problems. This type of intelligent system health analysis, based on the combination of electrical and effectual data, can provide savings in energy costs by ensuring that equipment operates as efficiently as possible and savings in equipment and repair costs by identifying problems as early as possible.

Although the control logic section is described above as being composed of a microprocessor, the control logic section may be composed of a digital logic, or a combination of a microprocessor and digital logic. In accordance with a preferred embodiment, the control logic section is composed of microprocessors from Microchip and/or Motorola. It is further contemplated that programmable logic devices from Altera may be employed in the construction of the control logic section. The control block and the microprocessor may be implemented either as an actual processor IC, as programmable logic, as an ASIC, or any other suitable method.

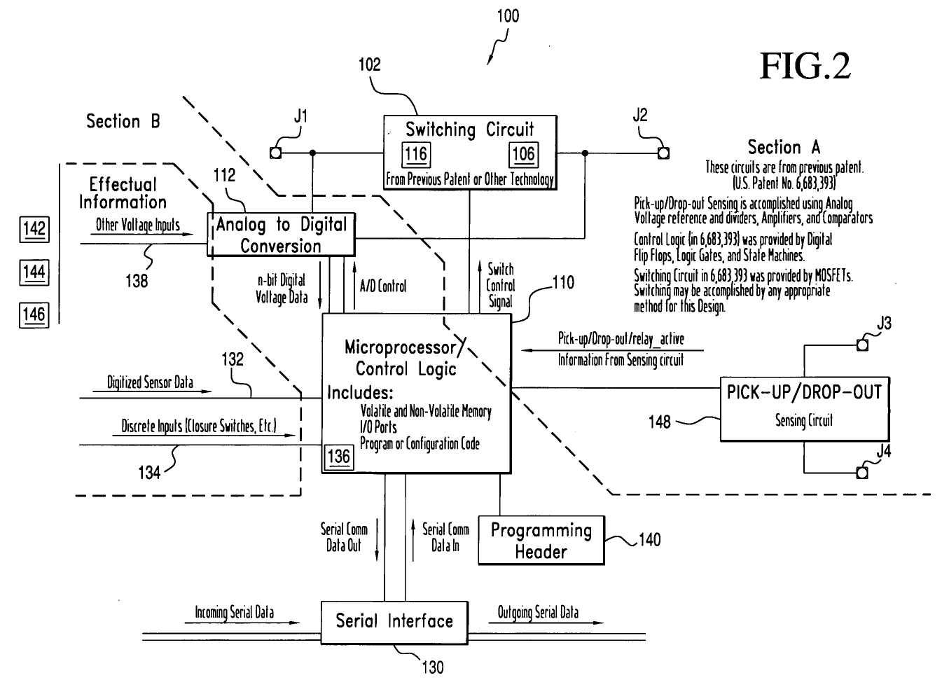

A preferred embodiment of the present intelligent relay system 100 is disclosed with reference to FIG. 2. As briefly discussed above, the intelligent relay system 100 provides control and monitoring of power controlled systems. The intelligent relay system 100 controls power, and ultimately the underlying systems, by allowing or limiting the flow of electrical current through the switching assembly 106 (Terminal J1 to J2). Control of the switching assembly 106 is based on various data inputs and control parameters. As will be described below in greater detail, the present intelligent relay system 100 can operate as a stand alone unit, connected to a control system via the serial interface, or as part of an intelligent relay systems, that is, a network (see FIGS. 13, 14 and 15).

In accordance with the embodiment described herein, the control inputs are the voltage conditions on the pick-up/drop-out inputs J3, J4, current or voltage parameters measured by the analog to digital converter 122 (either from terminals J1 and J2 or from external voltage inputs), sensor iput data, discrete inputs (such as an operator or switch input), and serial data or commands communicated via the serial interface 130 (discussed below in greater detail). While specific control inputs are described herein with reference to a preferred embodiment of the present invention, those skilled in the art will appreciate that other control inputs may be employed without departing from the spirit of the present invention.

These control parameters determine what input values or combination of input values result in the switching assembly 106 being turned on or off. The control parameters of the present intelligent relay system 100 are reconfigurable via a serial interface 130 or a programming header and may be adjusted under the control of a personal computer 112 as described above with reference to FIG. 1.

The intelligent relay system 100 shown in FIG. 2, generally includes relay components (see Section A) and intelligent control components (see Section B). With regard to the intelligent components found in Section B, these components provide the present intelligent relay system 100 with additional capabilities beyond any relay on the market today. These capabilities include the ability to sense power usage (voltage and current); the ability to sense power factor, the ability to sense operating conditions related to the Unit Under Control (UUC); the ability to sense effectual information (described below in greater detail); the ability to base operation on other values than just pick-up/drop-out voltage (operation can be based on sensor data, voltage data, or discrete inputs); the ability to base operation on the combination of values from pick-up/drop-out voltage, various sensors, and various inputs; the ability to communicate with other relay systems 100 and with a control system (via serial links); the ability to communicate power usage and other power information (such as current, power factor, and rates of change); the ability to communicate pick-up/drop-out conditions; the ability to communicate switching assembly 106 conditions (on, off, or failure); the ability to communicate operating and effectual data; the ability to override relay operation via the communication system; the ability to modify or change operating parameters via the communication system (or a programming header for a stand-alone unit).

The overwhelming versatility of the intelligent control components is achieved by the inclusion of the programmable microprocessor/control logic 110. The microprocessor/control logic 110 is sufficiently robust to permit programming thereof for control of the many functions desired in accordance with the present invention.

More specifically, the microprocessor/control logic 110 allows the intelligent relay system 100 to be configured to accept numerous iputs and to select which input value or combination of input values determines the switching assembly 106 condition. It is anticipated the microprocessor/control logic 110 may be comprised of a single microprocessor integrated circuit, an ASIC, a programmable logic integrated circuit, or a combination of these devices. In accordance with a preferred embodiment, a combination of an 8-bit microprocessor and a programmable logic device are used.

The microprocessor/control logic 110 provides serial communication. That is, the microprocessor/control logic 110 formats messages to be transmitted among various intelligent relay systems connected in a network and similarly accepts messages transmitted among the various intelligent relay systems. The messages transmitted over the network include header, message type, body, and footer information. Header information includes source address (identifies unit transmitting the message) and destination address (identification of unit or units the message is intended for) information. The message type is chosen from data (information to control system or other relays), command (specific command to force switches on or off or to command the relay to report information), parameters (changes to the control parameters of a relay and neighbor address (special message that contains the address of the intelligent relays nearest neighbor in the communication chain). The body of the message includes the specific data, command, or parameters transmitted. The information footer includes an error detection value and an End of Message (EOM) term.

The microprocessor/control logic 110 also provides switch control logic that ultimately controls operation of the switch assembly. This logic/software combination generates the switch control signal based on the control parameters set in non-volatile memory of the microprocessor/control logic 110. This component is implemented as a combination of logic and software to permit faster reaction to some input values (such as current limits or emergency conditions) while allowing parameters to be modified.

The microprocessor/control logic 110 also functions to provide a control parameter memory 136. The control parameter memory 136 is located internally to the microprocessor/control logic 110. The control parameter memory 136 is non-volatile memory (FLASH memory in accordance with a preferred embodiment) that stores the values that determine what inputs and what combination of inputs determine the output of the switch control logic. As those skilled in the art will certainly appreciate, the FLASH based microprocessor and programmable logic permits the sub-routine or algorithm to be changed as well as the parameters that control the algorithm. Control parameter memory 136 settings also determine what input information is reported to the microprocessor/control logic and at what intervals or thresholds to report.

The microprocessor/control logic 110 receives inputs from various sensors 132, devices (such as the analog to digital converter 132), and sub-systems 134, 138. The microprocessor software converts all data, whether serial or parallel to a usable format and converts input values into the terms that are needed by the system. For instance, raw data may need to be converted to a voltage (in units of Volts), a current (in units of Amps), or a temperature (in units of degrees C,).

In addition to the microprocessor/control logic 110, the present intelligent relay system 100 includes analog-to-digital conversion achieved via the analog to digital converter 122. The analog-to-digital conversion functionality may be incorporated into the microprocessor/control logic or composed of one or more analog-to-digital converter integrated circuits. The analog-to-digital converter 122 performs two primary functions (a) monitoring power conditions by sensing voltage and current at the control terminals J1, J2 and (b) converting input voltages from other inputs 138. Additionally, the analog-to-digital converter 122 maybe used in place of pick-up/drop-out sensing to measure voltages at the control input J3, J4.

The intelligent relay system 100 monitors power conditions by sensing voltage and current at the switch terminals J1, J2. The analog-to-digital converter 122 measures the voltage between the terminals J1, J2 and the voltage between each terminal and ground (Ground or Common voltage is not shown in FIG. 2). By measuring the voltages at the switch terminals J1, J2, the present intelligent relay system 100 produces valuable information. Specifically, input voltage is determined by measuring the difference between the input terminals and ground. Input current is determined by reading the voltage across the switching assembly 106 when the switching assembly 106 is on (conducting) or across a reference resistor. When using a switching assembly 106 with a known ON resistance (such as a MOSFET based switch) the switching assembly 106 can double as sense resistor for current measurements. A Hall effect current sensor may also be used and the voltage output of the sensor converted to a current value. Power consumption is determined by multiplying input voltage by input current.

Switch error or failure is determined by comparing the state of the switch control signal with the voltage across the switching terminals J1, J2 error or failure information can be derived. If the control signal state indicates that the switching assembly 106 should be conducting, a relatively low voltage should exist between the two terminals (voltage of J1 in reference to J2). This relatively low voltage is based on Ohm's law (V=IR) and is purely the effect of the on resistance of the switching assembly 106 and the current flowing through the switching assembly 106. An efficient switching assembly design utilizes as low an on resistance as feasible so that the voltage measured across the switching assembly should be orders of magnitude less than the input voltage. Likewise, if the switch control signal indicates that the switching assembly 106 should not be conducting, then voltage across the switching assembly 106 should be the same as the input voltage. By comparing the voltage across the switching assembly 106 to the switch control signal, the operational capability or failure of the switching assembly 106 can be determined and the control system notified.

Power factor (for alternating current systems) is determined by comparing the zero crossing time of the input voltage to the zero crossing time of the input current and determining a “phase time”. The phase time value is compared to the period time value (1/frequency to determine the power factor phase information. To actually determine power factor, the power consumption value must also be considered. The microprocessor and software is capable of performing the calculation necessary for all power factor information. U.S. Pat. No. 6,307,345, entitled “RESONANT CIRCUIT CONTROL SYSTEM FOR STEPPER MOTORS”, filed Feb. 1, 2000, details a method for dynamically providing power factor correction for use in addition to the intelligent relay system and is incorporated herein by reference.

The present intelligent relay further includes a serial interface 130. The serial interface 130 of the present intelligent relay system 100 is composed of data buffers (such as RS-232 or RS-485 buffers), relay addressing registers, and destination decoding logic. Where the relay system 100 is employed in a daisy chain configuration as described below in greater detail (see FIG. 13), the serial interface 130 passes all messages to the next relay system 100 in the daisy-chain path (in either direction), determines which messages are intended for the intelligent relay system 100, passes pertinent messages to the microprocessor/control logic 110, and inserts messages from the microprocessor/control logic 110 into the outgoing data stream. The relay addressing register may be changed dynamically by parameter messages sent to the various relay systems 100 via the communication system.

Every message is received from the previous relay system 100 in the network and passed to the next relay system 100 in the network This “daisy-chain” configuration allows a large number of relays to be connected to a single serial port of the networked control system.

The present intelligent relay system 100 can be configured for single serial communications links (for commercial and low cost systems) or multiple serial links (to provide redundant capabilities for more fault tolerant systems such as military applications). When the intelligent relay system 100 is configured with multiple serial communications links, the serial communication sub-system coordinates communication between the redundant links.

The present intelligent relay system 100 also includes a programming header 140 that interfaces the programming inputs to the microprocessor/control logic 110, programmable logic and other programmable components to allow the present intelligent relay system 100 to be configured separately from the network for maintenance or standalone operation.

Effectual inputs 138 are also provided in accordance with the present invention. The effectual inputs 138 are defined as sensory inputs that have to do with the effects of the power control. This type of input can be a photometer to measure available light when the relay is controlling lights, temperature sensors when the relay is controlling HVAC equipment, the temperature of the Unit-Under-Control and vibration sensors to monitor equipment noise. Effectual data can be any information not related to the actual voltage and current of the power being controlled or not relating directly to the decision to turn a device on or off. In accordance with a preferred embodiment of the present intelligent relay system 100, one relay can collect effectual data and transmit this data to the rest of the intelligent relay systems (via the serial interface 130) for use by other relays. A relay system 100 can be configured to operate based solely on information collect by other relay systems or based on a combination of its own inputs and data transmitted via the serial interface 130.

Power information collected by one relay system 100 (power factor, current, voltage) can be used as effectual data, or effectual inputs, for other relay systems 100. Effectual data is collected primarily by three methods (a) digital sensors, (b) analog sensors, and (c) switch closure.

Digital sensors 142 provide a digital value that is input to the microprocessor/control logic 100 either as serial or parallel digital data. Serial data is the preference in accordance with a preferred embodiment of the present invention because it provides easy connection to multiple sensors using the least amount of conductors.

Analog sensors 144 provide an analog equivalent representation of the value being measured. The analog equivalent is usually an analog voltage (although there are exceptions such as the time between two pulses, a frequency, or a current that must be converted to a voltage). The analog sensor 144 preference in the present intelligent relay system 100 is analog sensors that output a voltage. The voltage is then converted to a digital value in the analog-to-digital converter 122. Analog current can simply be converted to a voltage using the appropriate resistor and buffering the resulting voltage for conversion by the analog-to-digital converter 122. Frequency and timing can be converted to a digital value in the microprocessor/control logic 110.

Switch closure 146 provides the ability read the condition of a switching assembly 106 such as a push-button or toggle switch or a magnetic reed relay to detect whether a door or window is opened or closed. These inputs are composed of a connection to ground and a connection to a known voltage (VCC,) through a pull-up resistor. The input value at the pull-up resistor can be directly connected (or connected through an isolation system such as an opto-isolator) to a logic input of the microprocessor/control logic 110. The microprocessor/control logic 110 simply reads the input as a high or low digital value (or input).

The relay components in accordance with a preferred embodiment of the present intelligent relay generally include components described in prior U.S. patent application Ser. No. 10/684,408, filed Oct. 15, 2003, entitled “MOSFET BASED, HIGH VOLTAGE, ELECIRONIC RELAYS FOR AC POWER SWITCHING AND INDUCTIVE LOADS”, U.S. patent application Ser. No. 10/386,665, filed Mar. 13, 2003, entitled “MOSFET BASED, HIGH VOLTAGE, ELECTRONIC RELAYS FOR AC POWER SWITCHING AND INDUCTIVE LOADS” and U.S. patent application Ser. No. 10/034,925, filed Dec. 31, 2001, entitled “MOSFET BASED, HIGH VOLTAGE, ELECTRONIC RELAYS FOR AC POWER SWITCHING AND INDUCTIVE LOADS”, which is currently U.S. Pat. No. 6,683,393, which are incorporated herein by reference. However, the relay components of the intelligent relay may differ in form and design from those described above, but provide the same functionality and serve as components to the intelligent relay system, without departing from the spirit of the present invention. The emphasis of the present intelligent relay system is more focused on the assembly of these components into a new entity, than with the details of each component.

In general, the relay components include a relay 102, pick-up/drop-out sensing 148 and microprocessor/control logic 110. In accordance with a preferred embodiment of the present invention, the relay 102 may include a MOSFET based circuit as described in U.S. Pat. No. 6,683,393 or any other switching assembly that can be operated by the microprocessor/control logic 110 (electronic or electromechanical), the pick-up/drop-out sensing 148 is analogous to the sense coil in a conventional electromechanical relay detecting voltage levels on separate set of signals or terminals J3, J4 from the voltage being switched J1, J2 and the control logic is a simple state machine (coupled to flip-flops and combinational logic) as described in U.S. Pat. No. 6,683,393.

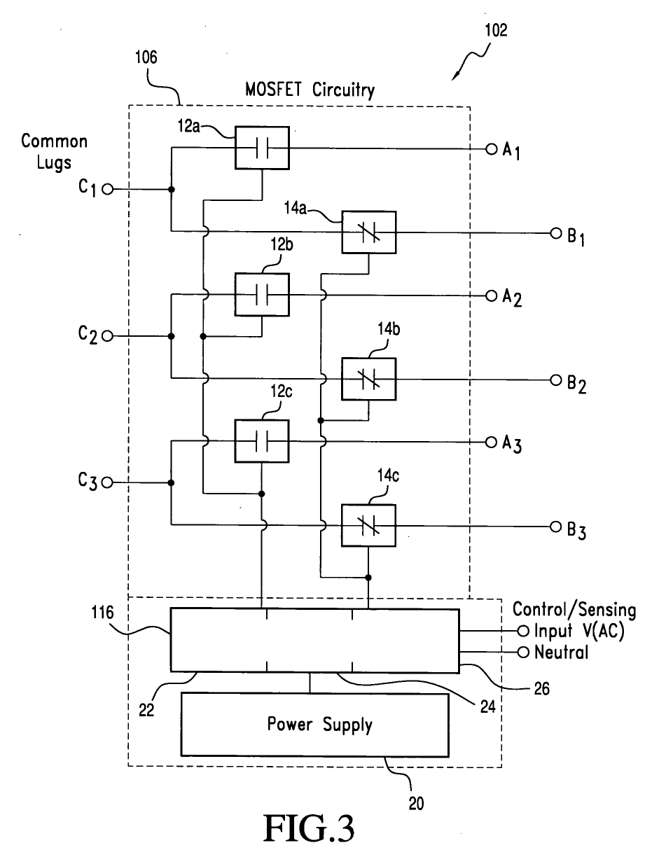

More specifically, and with reference to FIGS. 3 to 11, the relay 102 in accordance with a preferred embodiment of the present invention is composed of a MOSFET switching circuit 28 selectively switching between switch conducting (on) and switch isolation (off) and a power supply. The MOSFET switching circuit 28 is controlled by the coil/control input 104 and ultimately a transformer arrangement 116, which in its most basic form is composed of first and second transformers 30, 32 (including transformer driving circuitry coupled to each MOSFET switching circuit 28. The transformers 30, 32 are linked to the microprocessor/control logic 110 for controlling operation of the first transformer 30 and the second transformer 32. The first transformer 30 selectively applies a predetermined first voltage to the MOSFET switching circuit 28 that establishes the MOSFET switching circuit 28 in switch conducting. A second transformer 32 is coupled to the MOSFET switching circuit 28. The second transformer 32 selectively applies a predetermined second voltage to the MOSFET switching circuit 28 that establishes the MOSFET switching circuit 28 m switch isolation.

Generally, the present relay 102 provides for handling the problems associated with switching AC power through the use of solid-state devices. With this in mind, the present intelligent relay system 100 maybe utilized with relays 102 embodied in a number of possible configurations from single-pole, single-throw to multiple-pole, multiple-throw. In accordance with one embodiment of the present invention, and as disclosed in FIG. 3, the relay 102 may be configured as a three-phase relay having both normally open 12a, 12b, 12c and normally closed 14a, 14b, 14c contacts. The disclosed three-phase configuration may also be referred to as a triple-pole, double-throw relay.

In addition to generally handling the problems associated with switching AC power through the use of solid-state devices, the present invention also provides for the utilization of normally closed contacts (or switches) without the need for additional power inputs. Normally open contacts are generally easy to construct and readily available for use in conjunction with solid-state relays. However, prior systems attempting to incorporate normally closed contact into a solid-state relay have been required to provide an additional power input.

As will be described below in the various embodiments of the present invention, a small amount of power is gleaned from the circuit to be controlled. In the case of relays for switching voltages (AC or DC) in accordance with the present invention, one voltage source exists that is to be switched and another voltage source is identified as the “sense voltage”. When there is no voltage on the “sense voltage” inputs, the relay is said to be in the normal condition. When a certain voltage is applied to the “sense voltage” inputs, the relay is considered activated.

The power applied to the “sense voltage” inputs is used to power the operation of the relay 102. This is how most (if not all) solid-state relays operate. The problem arises as to how one may power the normally closed parts of the circuit when no power exists at the sense voltage input. In accordance with a preferred embodiment of the present invention, and as will be discussed below in greater detail, all inputs of the relay 102, both switched inputs and sense inputs, are connected to rectifiers so that a voltage differential existing between any two input pins becomes a voltage source. The voltage source is used to power the relay 102 and provide power to the normally closed contacts when no power exists at the sense voltage input. This power source also allows the relay to perform monitoring and communication functions regardless of the condition of the sense input.

The present relay 102 does not work when there are no voltages connected to any of the input pins of the relay 102. However, when this occurs, there is nothing to control and there is no need for the normally closed condition. As such, the inability of the relay 102 to operate under these conditions is trivial.

As is described below with reference to the various embodiments disclosed in accordance with the present invention, the present relay 102 uses various combinations to provide the proper operating voltage for the relay 102 from the rectified voltage. The relay 102 typically rectifies the voltage into a high-voltage capacitor and then uses either shunt regulation of DC/DC conversion to lower the voltage to the proper operating voltage. If the voltage is too low, a step-up DC/DC power supply must be used. It is also contemplated that synchronous rectification may be used so that high voltages do not have to be dealt with. It is further contemplated that a combination transformer/capacitor may be used to convert the waveform directly from the rectifier without using a high voltage capacitor. The power supply is really insignificant; it is the concept of pulling power from the circuits under control that present invention aims to achieve.

With reference to FIG. 3, the basic configuration of a triple-pole, double-throw circuit constructed utilized in the present electronic relay 102 is disclosed. As the schematic illustrates, the electronic relay 102 is divided into three major systems: the MOSFET switching assembly 106 which conducts and blocks the flow of electricity, transformer arrangement 116 which includes all of the analog and digital electronics permitting the relay to function in a desired a manner and the power supply 20 providing DC power to the components making up the present relay 102. As will be discussed below in greater detail, the transformer arrangement 116 is composed of transformers 36, 52 and transformer driving circuitry 22 that provides isolated gate to source voltages critical to the operation of the present relay 102.

With reference to FIGS. 3 and 4, the triple-pole, double-throw relay 102 includes MOSFET switching assembly 106 composed of a plurality of MOSFET switching circuits 28 (i.e., open and closed contacts 12a-c, 14a-c) selectively actuated to control the flow of electricity between opposed terminals. A schematic of the basic MOSFET switching circuit 28 used in accordance with a preferred embodiment of the present invention is disclosed with reference to FIG. 4. The MOSFET switching circuit 28 includes four MOSFETs Q1, Q2, Q3, Q4. The MOSFETs are shown complete with their inherent diodes, gates, sources and drains. MOSFETs Q1 and Q2 are power MOSFETs capable of sustaining large Vds (drain to source voltages) when Vgs (gate to source voltage)=0V and are capable of conducting relatively large amounts of current with extremely low resistance and low Vds when Vgs>Threshold. MOSFETs from a number of manufacturers have been tested for use in accordance with the present invention. In accordance with a preferred embodiment of the present invention, that is, for use in conjunction with a 480V AC relay, 1000V MOSFETs from IXYS are used as they are available with higher current (20A or more) and lower resistance ratings. However, MOSFETs from other manufacturers, for example, On Semiconductor, International Rectifier and Harris, may be used in accordance with the present invention without departing from the spirit thereof.

With regard to MOSFETs Q3 and Q4, they have been selected for speed, low capacitance, low resistance and small size. The Vds of these devices need not be over 20V and the Ids (drain to source current) maybe in the mA range. MOSFETs meeting these requirements are currently available from numerous manufacturing sources, including, but not limited to, Vishay and Supertex. While specific suppliers are noted, those skilled in the art will appreciate the variety of different MOSFETs that maybe utilized in accordance with the present invention.

With reference once again to FIG. 4, MOSFETs Q1 and Q2 are connected in a bipolar arrangement. Such a bipolar connection is well known in the art. MOSFETs Q1 and Q2 are drain connected MOSFETs. Drain connected MOSFETs are utilized in accordance with a preferred embodiment of the present invention as they have shown positive results during initial testing. However, it is contemplated that source connected MOSFETs may similarly be utilized without departing from it the spirit of the present invention.

In operation, the MOSFET switching circuit 28 disclosed in accordance with a preferred embodiment of the present invention operates in a switch conducting mode (that is, on) when MOSFETs Q1 and Q2 conduct. MOSFETs Q1 and Q2 conduct when there is a positive voltage applied between G1 and S1/S3 and between G2 and S2/S4. In addition, this switch conducting mode requires that no voltage is respectively applied between G3 and S1/S3 and between G4 and S2/S4. In order to ensure that Q3 and Q4 remain off, a resistor may be connected between the gate and drain of MOSFETs Q3 and Q4 to eliminate any capacitively coupled charges that might build up from the influence of the AC power. It is also contemplated that a depletion mode MOSFET may be used to assist in eliminating unwanted gate voltages on MOSFETs Q3 and Q4.

The MOSFET switching circuit 28 operates in a circuit isolation mode (that is, the MOSFET switching circuit is off) when a predetermined voltage is applied to MOSFETs Q3 and Q4. However, turning the MOSFET switching circuit 28 off, and keeping it off, is far more difficult than turning on the MOSFET switching circuit 28 as discussed above. This difficulty arises from the fact that MOSFETs exhibit a great deal of capacitive characteristics and AC signals may pass through capacitors. As a result of the capacitive nature of MOSFETs, a positive charge can be coupled to the gate in relationship with the source node. When this occurs, the MOSFET briefly turns on. A MOSFET circuit that can conduct DC voltage in two directions may, therefore, not be suited for switching AC power.

With this in mind, the present MOSFET switching circuit 28 has been developed in an effort to ensure that the switch accurately is turned off, and remains off. In accordance with the disclosed MOSFET switching circuit 28, MOSFETs Q1 and Q2 block the passage of electricity when Vgs=0. To ensure that Vgs₁=0 and Vgs₂=0, the device providing a voltage to G1 and G2 is turned off and voltage is applied to G4 (in relationship to S2/S4) and applied to G3 (in relationship to S1/S3). By positively biasing the Vgs voltage of MOSFETs Q3 and Q4 a low resistance is established between the gate and source of MOSFETs Q1 and Q2 (typically less than 10 ohms). If any parasitic charge is coupled to G1 and/or G2, it is quickly dissipated by a low resistance connection provided by MOSFETs Q3 and Q4, and the switch remains off.

It should be understood that there is no relationship between the voltage on G1 and the voltage on G2. In addition, no relationship exists between these voltages and the ground potential. When both MOSFETs Q1 and Q2 are conducting, the voltages on G1 and G2 will be very close but separated by a voltage equal to the current through MOSFETs Q1 and Q2 times the combined resistance of the MOSFETs. Further, when MOSFETs Q1 and Q2 are conducting AC power, the voltage on G1 and the voltage on G2 will be some small DC voltage above the AC voltage, but exactly in phase with that voltage. Such an arrangement is necessary because the gate voltage must be greater than the source voltage at all times for the MOSFETs to conduct electricity.

Similarly, the voltage on G3 must be referenced only to S1/S3 and likewise the voltage at G4 must be referenced only to S2/S4. When the MOSFET switching circuit 28 is not conducting, the S1/S3 node maybe at AC potential, and, therefore, G3 must be at a constant voltage above AC, while S2/S4 may be at ground potential with G3 at a voltage above ground (0V).

As mentioned above, the present relay utilizes a specific transformer arrangement 22 to control the MOSFET switching circuits 28 employed in accordance with a preferred embodiment of the present invention. Generally, each MOSFET switching circuit 28 is controlled by two distinct power sources. In order to maintain the unique voltage relationships required by the MOSFET switching circuit 28 described above, the voltage source must be isolated from all other voltages. In accordance with a preferred embodiment of the present invention, a pair of transformers 30, 32 is utilized in applying the required isolated voltages to the MOSFET switching circuit 28. That is, transformer coupled power is utilized to provide the isolated voltages required in operating the MOSFET switching circuit 28 described above. It is further contemplated that a battery or charged capacitor may be used in accordance with the present MOSFET switching circuit, and the voltage may be applied or removed from the gate using optical isolation. Other similar isolated power sources may also be used without departing from the spirit of the present invention.

FIG. 5 discloses a preferred transformer arrangement 22 of the coil/control input for powering the MOSFET switching circuit 28 depicted in FIG. 4. As shown in FIG. 5, the first transformer 30 includes a primary winding 34 connected to an AC driving circuit 36, a first secondary winding 38 and a second secondary winding 40. Each of the first and second secondary windings 38, 40 is connected to a full bridge rectifier 42, 44 with capacitors 46, 48 on the rectifier outputs. These rectified outputs are labeled with reference to their relationship to the gates and sources of MOSFETs Q1 and Q2. When an AC source is applied to the first transformer 30, positive voltage is quickly produced on each gate relative to its source. The transformer arrangement 22 also includes capacitors 46, 48 which add stability to the power MOSFETs Q1 and Q2 and helps limit the problems associated with parasitic charges.

The second transformer 32 is similarly configured for MOSFETs Q3 and Q4. As such, the second transformer 32 includes a primary winding 50 connected to an AC driving circuit 52, a first secondary winding 54 and a second secondary winding 56. Each of the first and second secondary windings 54, 56 is connected to a full bridge rectifier 58, 60. The rectified outputs are labeled with reference to their relationship to the gates and sources of MOSFETs Q3 and Q4. As such, when an AC source is applied to the second transformer 32, positive voltage is quickly produced on each gate relative to its source. This positive voltage turns of the MOSFET switching circuit 28, and keeps the MOSFET switching circuit 28 off.

In use, when the first transformer 30 is turned off and the second transformer 32 is turned on, the gates of MOSFETs Q3 and Q4 charge rapidly, since there is little capacitance. When the gates are sufficiently charged, MOSFETs Q3 and Q4 discharge the Vgs voltage of Q1 and Q2, turning the main power of the MOSFET switching circuit 28 off and holding it off by providing a low resistance between the gate and source of MOSFETs Q1 and Q2. MOSFETs Q3 and Q4 are less susceptible to capacitive parasites and so did not require additional capacitance to protect them from such effects. Since MOSFETs Q3 and Q4 have much lower capacitance, the gate charge will drain quickly when the second transformer 32 is turned off. In addition, system efficiency maybe improved by providing MOSFETs Q3 and Q4 with high resistance at their respective gate to source resistors.

Operation of the disclosed transformer system 22 is enhanced by the provision of respective resistors 62, 64 between the first and second rectifiers 42, 44 and their respective capacitors 46, 48. The provision of a resistor 62, 64 between the first and second rectifiers 42,44 enhances operation by limiting current flow while MOSFETs Q3 and Q4 are turning off. Because the MOSFETs only require power while switching (enough current to charge or discharge the gates), the power delivered by the transformers 30, 32 can be small. For example, the inventor has used a 5V CMOS circuit as a driver for the transformers. This minimal current requirement makes electronic relay design even more power efficient.

Transformer coupled power is utilized in accordance with a preferred embodiment of the present invention as transformer coupling reacts relatively rapidly and is also relatively efficient. Also, transformer coupling allows for the grouping of functions while maintaining proper isolation. For example, G1 and G2 can both be driven by secondary windings 38, 40 of the same first transformer 30. Similarly, G3 and G4 are driven by secondary windings 54, 56 of the same second transformer 32. Transformer couplings can easily provide 1500V of isolation while quickly and efficiently coupling power so that no storage device is needed. In fact, the use of isolated power sources in accordance with the present invention, allows for response times in the range of nanoseconds. It is contemplated that the ability of the present circuits to offer fast switching makes them highly appropriate for use in the manufacture of electronic circuit breakers.

It is anticipated the basic circuit can be implemented using a photovoltaic device (such as the Clare FDA215 or the Vishay LH1262C photovoltaic drivers) to drive the MOSFETs instead of the transformer coupled system. However, it should be appreciated that the transformer coupled circuit substantially improves (reduces) the switching time over that of the photovoltaic driven system.

The embodiment described with reference to FIGS. 4 and 5 may be replaced with the three MOSFET system disclosed with reference to FIGS. 4a and 5a. In accordance with this embodiment, first and second power MOSFETs Q1, Q2 and a small signal MOSFET Q3 are employed in the construction of a switching circuit 28a. The first and second power MOSFETs Q1, Q2 are connected to terminal 1 and terminal 2, as well as to each other via their source nodes. When connecting the first and second power MOSFETS Q1, Q2 by their source nodes in this way, only one small signal MOSFET Q3 is required to remove the voltage from the gates of the first and second power MOSFETS Q1, Q2.

This functions to simplify the overall system without altering the switching theory as described above. To cause the first and second power MOSFETs Q1, Q2 to conduct, transformer 1 (not shown) outputs into the rectifiers 42a, 44a causing a voltage to be placed on the gates of the first and second power MOSFETs Q1, Q2 relative to the common source, while transformer 2 (not shown) is off. As such, no voltage exists on the gate of the small signal MOSFET Q3.

To turn off the first and second power MOSFETs Q1, Q2, transformer 1 is no longer driven but transformer 2 is driven. This causes a voltage on the gate of the small signal MOSFET Q3 so that the voltage on the gates of the first and second power MOSFETs Q1 and Q2 is quickly dissipated.

As discussed above and as those skilled in the art will certainly appreciate, the circuitry described above provides for the application of normally closed contacts 14a, 14b, 14c without the need for additional power inputs. The present arrangement achieves this by utilizing the power generated by the power supply 20 of the control logic section 18 to power the normally closed contacts 14a, 14b, 14c when no power is supplied via the “sense voltage” input.

More specifically, a small amount of power is gleaned from the control logic section 18. All inputs of the relay 10, both switched inputs and sense inputs, are connected to rectifiers 42, 44, 58, 60 so that a voltage differential existing between any two input pins becomes a voltage source. The voltage source is used to power the relay 10 and provide power to the normally closed contacts 14a, 14b, 14c when no power exists at the sense voltage input. This power supply 20 also allows the relay 10 to perform monitoring and communication functions regardless of the condition of the sense input.

In accordance with a further embodiment of the present invention, the MOSFET switching circuits 28, as well as the transformer assembly 22 discussed above, may be combined to provide for improved power handling and isolation. Specifically, and with reference to FIG. 5, three of the MOSFET switching circuits 28 described above are combined to produce an AC relay block 66 adapted for functioning as an AC power relay. As will be better appreciated based upon the following discussion, each AC relay block 66 is well suited for controlling the flow of electricity therethrough and may consequently be used in various power control applications (e.g., power control with inductive loads, multiple-pole/multiple throw systems, etc.).

Generally, a first MOSFET block 28′ (composed of the MOSFET switching circuit 28 described above with reference to FIG. 3) and a second MOSFET block 28″ (composed of the MOSFET switching circuit 28 described above with reference to FIG. 4) are electrically connected in series between a first terminal 68 and a second terminal 70. An electrical connection member 72 connects the first MOSFET block 28′ and the second MOSFET block 28″, and a third MOSFET block 28′″ (composed of the MOSFET switching circuit 28 described above with reference to FIG. 5) extends between the electrical connection member 72 and ground 74.

This system is designed to allow power to flow from a first terminal 68 to a second terminal 70 in either direction by turning on the first and second MOSFET blocks 28′, 28″, and turning off the third MOSFET block 28′″. In this mode, AC or DC power can flow from a source at the first terminal 68 to a load at the second terminal 70 or in the reverse direction from a source at the second terminal 70 to a load at the first terminal 68.

The MOSFET blocks 28′, 28″, 28′″ behave as variable resistors, and operation of the disclosed AC relay blocks 28′, 28″, 28′″ may be explained in terms of resistance. In the conduction mode with the first and second MOSFET blocks 28′, 28″ turned on, the first MOSFET block 28′ and the second MOSFET block 28″ have low resistance (less then 1 ohm, typically less then 1/10 ohm) and the third MOSFET block 28′″ has high resistance (above 10 Meg Ohm, possibly as high as 100 Meg Ohm).

With reference to FIG. 7, the purpose of the third MOSFET block 28′″ is best appreciated when one considers operation of the AC relay block 66 in isolation mode. Specifically, when power must be isolated from the load, that is, when the AC relay block enters isolation mode, the first MOSFET block 28′ and the second MOSFET block 28″ are turned off and the third MOSFET block 28′″ is turned on. When the AC relay block 66 is placed in isolation mode as described above, the first and second MOSFET blocks 28′, 28″ are considered to behave like high value resistors (greater then 10 Meg Ohm each) and the third MOSFET block 28″ behaves like a low value resistor (less than 1 ohm). As such, when the AC relay block 66 is in isolation mode it behaves in the manner shown in FIG. 6, with the third MOSFET block 28′″ serving the purpose of a grounding circuit.

The inclusion of such a grounding circuit in isolation mode is necessary for many applications since the MOSFETs behave as variable resistors and not as actual switches providing a physical electrical gap. If the circuit consisted of only the first and second MOSFET blocks, although there would be a great deal of resistance between and the first terminal and the second terminal, there would still be a current path. If a load were small, or if the load terminal had no-load connected, a voltage would still be measured on the load terminal even when the MOSFET blocks were in isolation mode. By adding the third MOSFET block as a grounding circuit, such a problem is completely eliminated and a safer relay is produced.

With reference to FIG. 8, the AC relay block 66 disclosed in FIG. 6 is described with an inductive load 76 connected thereto. The problem with inductive loads is the inductive discharge caused by the changes in current through the inductor. When an inductive load is utilized in DC systems, the inductive discharge caused by the change in current of the inductor is commonly dealt with through the use of a diode in parallel with the inductive load. Such an arrangement is shown in FIGS. 9 and 9a. In order for the simple circuit solution shown in FIGS. 9 and 9a to be effective, however, the polarity of the power and the direction of the current through the inductor must be known. As such, the utilization of the diode, as with the DC system disclosed in FIGS. 9 and 9a, is not practical when an AC power source is applied. Specifically, when an AC power source is applied, the direction of the current through the coil (polarity of the voltage) when the system changes from conduction mode to isolation mode cannot be predicted. Furthermore, when multi-phase AC power is being controlled, it is difficult, if not impossible, to select when in the AC cycle each phase is to be switched. It is also desirably to switch all phases simultaneously.

In accordance with a preferred embodiment of the present invention, the AC relay block 66 disclosed in FIG. 6 is very capable of handling an inductive load 76. With reference to FIG. 8, and in accordance with a preferred embodiment of the present invention, the inductive load 76 is connected to the first terminal 68 and the AC power source 78 is connected to the second terminal 70. The function of this circuit is now described by way of example. Specifically, when the system is in conduction mode, the first MOSFET block 28′ and the second MOSFET block 28″ are in conducting mode (on) and the third MOSFET block 28′″ is in non-conducting mode (off). When the AC power is removed, and it is necessary to provide the inductive discharge with a path to ground, the second MOSFET block 28″ is placed in non-conducting mode (off) and the third MOSFET block 28′″ is placed in conducting mode (on). Referring to FIG. 10, this permits the inductive discharge to discharge to ground 74 without an excess of voltage being created. After the inductive discharge is completed, the system is switched to isolation mode (with the first and second MOSFET blocks 28′, 28″ off and the third MOSFET block 28′″ on). In fact, the inductive discharge mode is actually a modified isolation mode.

With reference to FIG. 11, the AC relay block 66 of FIG. 6 is disclosed in conjunction with the transformers and transformer driving circuitry discussed above. As discussed above, and in accordance with a preferred embodiment of the present invention, the transformers and transformer driver circuitry form part of the control logic section 18. The control logic section 18 includes all of the analog and digital electronics allowing the AC relay block 66 to function. In addition to the transformers and the transformer driving circuitry 22, the control logic section 18 includes control voltage sensing circuits 24 and control logic 26.

Once again with reference to FIG. 11, the transformers and the transformer driving circuitry provide the isolated gate to source voltages (Vgs) critical to the operation of the present AC relay block 66. In accordance with a preferred embodiment of the present invention, each MOSFET switching circuit 28′, 28″, 28′″ making up the AC relay block 66 is provided with an exclusive transformer set 22′, 22″, 22′″ including a set of two exclusively operating transformers. As such, three sets of transformers (6 transformers total) are required for operation of the AC relay block 66 disclosed with reference to FIG. 6.

Specifically, the first MOSFET block 28′, i.e., MOSFET switching circuit, is electrically coupled to first and second transformers 30′, 32′. The first transformer 30′ includes a primary winding 34′ connected to an AC driving circuit 36′, a first secondary winding 38′ and a second secondary winding 40′. Each of the first and second secondary windings 38′, 40′ is connected to a full bridge rectifier 42′, 44′ with capacitors 46′, 48′ on the rectifier outputs. These rectified outputs are labeled with reference to their relationship to the gates of MOSFETs Q1 and Q2 of the first MOSFET block 28′. When an AC source is applied to the first transformer 30′, its positive voltage is quickly produced on each gate relative to its source. The second transformer 32′ is similarly configured for MOSFETs Q3 and Q4 of the first MOSFET block 28′. As such, the second transformer 32′ includes a primary winding 50′ connected to an AC driving circuit 52′ a first secondary winding 54′ and a second secondary winding 56′. Each of the first and second secondary windings 54′, 56′ is connected to a full bridge rectifier 58′, 60′. These rectified outputs are labeled with reference to their relationship to the gates of MOSFETs Q3 and Q4 of the first MOSFET block 28′. As such, when an AC source is applied to the second transformer 32′, positive voltage is quickly produced on each gate relative to its source. Use of the transformer assembly 22′ in driving the first MOSFET block 28′ is described above.

Similarly, the second MOSFET block 28″ is electrically coupled to third and fourth transformers 30″, 32″. The third transformer 30″ includes a primary winding 34″ connected to an AC driving circuit 36″, a first secondary winding 38″ and a second secondary winding 40″. Each of the first and second secondary windings 38″, 40″ is connected to a full bridge rectifier 42″, 44″ with capacitors 46″, 48″ on the rectifier outputs. These rectified outputs are labeled with reference to their relationship to the gates of MOSFETs Q1 and Q2 of the second MOSFET block 28″. When an AC source is applied to the third transformer 30″, its positive voltage is quickly produced on each gate relative to its source. The fourth transformer 32″ is similarly configured for MOSFETs Q3 and Q4 of the second MOSFET block 28″. As such, the fourth transformer 32″ includes a primary winding 50″ connected to an AC driving circuit 52″, a first secondary winding 54″ and a second secondary winding 56″. Each of the first and second secondary windings 54″, 56″ is connected to a full bridge rectifier 58″, 60″. These rectified outputs are labeled with reference to their relationship to the gates of the second MOSFETs Q3 and Q4 of the second MOSFET block 28″. As such, when an AC source is applied to the fourth transformer 32″, positive voltage is quickly produced on each gate relative to its source.

The third MOSFET block 28′″ is electrically coupled to fifth and sixth transformers 30′″, 32′″. The fifth transformer 30′″ includes a primary winding 34′″ connected to an AC driving circuit 36′″, a first secondary winding 38′″ and a second secondary winding 40′″. Each of the first and second secondary windings 38′″, 40′″ is connected to a full bridge rectifier 42′″, 44′″ with capacitors 46′″, 48′″ on the rectifier outputs. These rectified outputs are labeled with reference to their relationship to the gates of the MOSFETs Q1 and Q2 of the third MOSFET block 28′″. When an AC source is applied to the fifth transformer 30′″, its positive voltage is quickly produced on each gate relative to its source. The sixth transformer 32′″ is similarly configured for MOSFETs Q3 and Q4 of the third MOSFET block 28′″. As such, the sixth transformer 32′″ includes a primary winding connected to an AC driving circuit 52′″, a first secondary winding 54′″ and a second secondary winding 56′″. Each of the first and second secondary windings 54′″, 56′″ is connected to a full bridge rectifier 58′″, 60′″. These rectified outputs are labeled with reference to their relationship to the gates of the MOSFETs Q3 and Q4 of the third MOSFET block 28′″. As such, when an AC source is applied to the sixth transformer 32′″, positive voltage is quickly produced on each gate relative to its source.

It is contemplated that multiple AC relay blocks may be operated in parallel for multi-phase control using only six transformers with multiple windings. For example, and considering a three-phase system (triple-pole, single-throw) it is contemplated that six transformers with six secondary windings each may be utilized. In accordance with a preferred embodiment of the present invention, toroid-core transformers operating at 3 MHz with a CMOS driving circuit are utilized. However, those skilled in the art will appreciate that other core configurations, frequencies, and driving circuits would similarly function and may be utilized without departing from the spirit of the present invention.

If one were to construct a system utilizing the present AC relay blocks in a double-throw arrangement, two parallel AC relay blocks 66′, 66″ could be utilized as shown in FIG. 12. Such a system requires twice as many transformers to ensure that each side of the system is capable of handling inductive discharge and complete AC power isolation. The double-throw arrangement disclosed in FIG. 12 employs first and second AC relay blocks 66′, 66″ connected in parallel so as to handle to separate power sources (one connected to the first terminal 80 and one connected to the second terminal 82) as well as a single load (connected to the common terminal 84). Similarly, the system disclosed with reference to FIG. 11 may handle two loads (one connected to the first terminal 80 and one connected to the second terminal 82) with a single power source connected to the common terminal 84.

Referring to FIG. 1, and with regard to those components considered to be external to the present intelligent relay system 100, they include a power system 150 (for example, an AC line power) linked to a load via the switching assembly 106 and local control input 152 for the coil/control input 104. In accordance with a preferred embodiment of the present invention, the present intelligent relay system 100 is adapted to be utilized in conjunction with switching assemblies and coil/control inputs that respond to an input threshold voltage by changing MOSFET switching circuits 28 from open to closed or from closed to open. The intelligent relay system 100 may further be controlled by a personnel computer 112 linked to the intelligent relay system, effectively overriding a local intelligent relay system similar to those discussed in prior U.S. patent application Ser. No. 10/684,408, filed Oct. 15, 2003, entitled “MOSFET BASED, HIGH VOLTAGE, ELECTRONIC RELAYS FOR AC POWER SWITCHING AND INDUCTIVE LOADS”, U.S. patent application Ser. No. 10/386,665, filed Mar. 13, 2003, entitled “MOSFET BASED, HIGH VOLTAGE, ELECTRONIC RELAYS FOR AC POWER SWITCHING AND INDUCTIVE LOADS” and U.S. patent application Ser. No. 10/034,925, filed Dec. 31, 2001, entitled “MOSFET BASED, HIGH VOLTAGE, ELECTRONIC RELAYS FOR AC POWER SWITCHING AND INDUCTIVE LOADS”, which is currently U.S. Pat. No. 6,683,393, used to change the pick-up/drop-out settings of the relay by downloading new set points from the personal computer, and used as a data acquisition system for the PC.

In particular, the present intelligent relay system 100 monitors electrical parameters such as voltage, current, power factor conditions, frequency, and switch/input conditions and reports this data back to the personal computer. For example, A/D converter measure voltage and current; frequency is monitored with systems known to those skilled in the art.

The intelligent relay system 100 can also monitor non-electrical stimuli (for example, via peripheral sensors 118 as shown in FIG. 1) such as temperature, humidity, motor RPM, ambient light and report this information back to the personal computer. In accordance with a preferred embodiment of the present invention, these sensors are off-the-shelf items. For example, and byway of example, the sensors might be a National Semiconductor LM70 Temperature Sensor, Dallas/Maxim DS18B20 Temperature Sensor or Sharp GP2Y0A02YK Proximity Sensor. In practice, decisions regarding control are made by a control register. AR parameters are weighted and programmed into the microprocessor/control logic 110 and the personal computer 112 can be used to alter the register. When the personal computer 112 provides new data, the operation of the microprocessor/control logic 110 can be changed on the fly. In essence, the present system 100 really has distributed processing and the personal computer 112 really gives the decision making to the microprocessor/control logic 110 in each relay system 100. The personal computer may, however, override the decision making ability of the relay microprocessors 110.

The present intelligent relay system 100 may also be used as a relay with sensor-based switching (switching based on preset sensor limits) or be used as an intelligent relay system based on the sensor data. The operating parameters can be set and monitored at the personal computer and the personal computer can send command information to the relay system to change or override sensor-based switching.

In operation, and in accordance with a preferred operating mode, the sense voltage condition becomes an input to the control logic section 108 (the sense voltage is the input to the coil in traditional electromechanical relays), which then uses this information, in conjunction with other information discussed below, to control operation of the relay 102.

With the sense voltage input for analysis by the control logic section 108, the control logic section 108 is programmed or configured to activate the switching assembly 106 based on the pick-up/drop-out conditions from the local control input 152, control signals from the personal computer 112, electrical parameters (voltage, current, power factor conditions, frequency, peripheral sensor 118 parameters and/or a combination of the above. In addition, the control logic section 108 can be programmed to operate on certain input conditions and simply report back to the personal computer 112 or the control logic section 108 can be reconfigured by the personal computer 112 during operation.

As mentioned above, the control logic section 108 is programmed for operation. This programming may take place prior to implementation and be “hard wired”. However, it is preferred that the control logic section 108 is connected to the personal computer 112 for ready programming of the control logic section 108 during operation of the present intelligent relay system 100. Data communication between the present intelligent relay system 100 and the personal computer 112 is accomplished using a standard data interface (or communication interface).

In accordance with a preferred embodiment of the present invention, the communication interface 114 maybe a parallel data interface or a serial data interface. The preferred embodiment currently uses an RS-485 serial interface 130 (see FIG. 2) to the personal computer 112. It is contemplated that USB and fiber-optic interfaces may be used. It is further contemplated that an Ethernet based network interface may integrated into some units. Each interface has application and we anticipate having different models with different data interfaces depending on the application.

The communication interface 114 illustrated in FIG. 1 is a combination of the hardware required to provide the appropriate signal (such as an RS-485 driver or a fiber-optic transceiver) and the logic to properly schedule and configure the transmitted data and interpret and manage the received data.

As mentioned above, the microprocessor/control logic 110 illustrated in FIG. 1 may be an actual IC or part of an IC as in the case of programmable logic configured to perform the tasks of a microprocessor. The microprocessor/control logic 110 (1) manages communication with the personal computer 112, (2) manages the collection of data from the electrical and peripheral systems, and (3) manages relay 102 switching.

More specifically, communication management includes receiving and interpreting packets from the personal computer 112, passing packets from relays 102 to the personal computer 112 (see FIG. 13), building report packets to send to the personal computer 112, sending data and packets to the personal computer 112 via the communication interface 114.

Data collection management includes receiving data from analog to digital converters 122 and processing that data so that it represents physical parameters such as voltage, current, or temperature, storing data—detailed data is stored in a circular buffer, summarizing the data. Data may be taken many times a second. All of this data cannot be stored or transferred to the personal computer 112. The microprocessor/control logic 110 produces a summary of the data. For example; voltage over a last 60 second period maybe summarized into—average value, high and low values, standard deviation, and power quality (how closely an AC waveform matches a perfect sine wave). Data collection also includes providing data for report packet to the personal computer 112.

Finally relay switching management includes producing the control signal to the relay switching assembly 106, interpreting the various data parameters to produce the proper control signal value and maintaining and changing the control parameters as required.

As discussed above, the present intelligent relay system 100 includes a data collection module 120. The data collection module 120 includes analog to digital (A/D) converter(s) 122, analog signal conditioning 124 (such as voltage dividers, amplifiers, and filters), optical isolators 126, and interface 128 to peripheral sensors 118. The peripheral sensors 118 may provide either analog or digital data to the data collection module 120. Digital data maybe passed directly to the microprocessor/control logic 110. Analog data from peripheral sensors will be conditioned, processed, and converted to digital format the same as analog signals from the on-board sensors. While A/D converters 122 are disclosed as being part of the data collection module in accordance with a preferred embodiment of the present invention, it is contemplated that the microprocessor might include an integrated A/D converter that would simplify the overall design.

Referring to FIG. 13, an alternate embodiment of the present intelligent relay is disclosed. The embodiment employs the concepts underlying the present invention in a daisy chain topology 200. By employing a daisy chain topology, a plurality of distinct intelligent relay systems 100 permit a single personal computer 112 to pass information along to each of the intelligent relay systems 100 linked to the daisy chain. More specifically, information is passed from the personal computer 112 to all intelligent relay systems 100 further down the daisy chain. Likewise, the plurality of intelligent relay systems pass information back to the personal computer through the daisy chain.

The networking underlying the daisy chain topology relies upon the basic principles understood by those skilled in the art. Briefly, a daisy chain configuration is a series bus wiring scheme in which, for example, device A is wired to device B, device B is wired to device C, etc.; that is, a first intelligent relay system 100 is wired to a second intelligent relay system 100, the second intelligent relay system 100 is wired to the third intelligent relay system 100, etc. The last device is normally wired to a resistor or terminator. All the devices may receive identical signals or, in contrast to a simple bus, each device in the chain may modify one or more signals before passing them on.

In accordance with yet a further embodiment of the present invention, an alternate networking scheme 300 is disclosed with reference to FIG. 14. This scheme provides for redundant communication among intelligent relay systems 100. In accordance with FIG. 14, a network built of intelligent relay systems with various loads (Unit Under Control) and local control inputs 352 is disclosed. FIG. 14 also depicts peripheral analog data inputs to the relay systems 100 and dual data communication paths (Data Corn.) between each relay system.

More specifically, a series of intelligent relay systems 100 are linked together under the control of local control inputs 352 and a personal computer smart load center 312. The smart load center 312 includes software that organizes and displays power information efficiently to n g operator oversight and monitoring requirements. Software provides a communication interface to the linked smart controller systems 100, handles control signals to the various systems 100, and receives, routes and archives signals from remote sensors attached to the smart load centers 312. Each of the intelligent relay systems 100 is responsible for control of a distinct load 302, although the intelligent relay systems 100 are linked for sharing of data facilitating optimal operation of the entire network 300.

In addition to providing for individual control of distinct loads 302, the series of intelligent relay systems 100 are linked to the personal computer smart load center 312. The smart load center 312 monitors and controls the network 300 on system level. With this in mind, the smart load center 312 gathers information from the various intelligent relay systems 100 networked together, analyzes the information and provides specific commands to the various intelligent relay systems 100. In fact, and given the individual control of the various intelligent relay systems 100, the smart load center 312 may control the intelligent relay systems 100 with distinct instructions based upon the needs of the individual intelligent relay systems.

With regard to the local control input, each relay system 100 has the option to include a local control or the local control can be passed on to other relay systems 100. This provides the ability for the relay systems 100 to actuate the load 302. AR of the inputs can be used locally or remotely. For example, the goal is to wire a house such that power cables only need to go to the load 302 and relay systems 100 which require the power. Ultimately, the personal computer smart load center 312 is the central control (brain), but other components (relay systems 100) are also capable of making control decisions. A further embodiment is disclosed with reference to FIG. 15. In accordance with this embodiment, a network 400 similar to that disclosed with reference to FIG. 14 is provided. However, this alternate embodiment includes redundant data communication paths between the various components making up the network 300. As such, single point communication failures or compound communication failures are not fatal to the operation of the network 300. Because of the use of redundant communication paths, the network 300 will continue to operate despite potential failures in the communication path.

As briefly mentioned above, the present invention provides for data collection, data management, decision capability, control and information management. Data collection is provided by the present relay systems 100 serving as control and sensory nodes. The present invention is, therefore, able to collect voltage, current and phase information from the relay systems 100, as well as from existing equipment. The relay systems 100 also provide the ability to collect effectual data such as, but not limited to, temperature and vibration.

Data Management is provided by the personal computer smart load centers. Data is collected from each control node, reduced, stored and analyzed. Data is analyzed for use in control decisions and for operational trend analysis. Decision capability is provided by the personal computer smart load centers. Control is provided by a combination of existing controllers, for example, various automated controllers currently known to those skilled in the art, and the personal computer smart load centers. The units will work together to provide local control and monitoring, allowing system level override as required. Information management is provided by a combination of the complete network and the personal computer smart load centers. This provides a system that allows other network users to access power system information and helps provide for system redundancy.

Regardless of the scheme chosen, the intelligent relay system in accordance with the present invention employs sensory inputs to enhance the operation of the relay. The intelligent relay system allows a piece of equipment to be operated under existing constraints but with additional capabilities, information, and control.

For example, a motor may be turned on due to input from a programmable controller, but the current, power factor, temperature, and efficiency can be monitored by the personal computer-based intelligent relay system. If the operation of the motor begins to change, the trend can be analyzed to determine if maintenance is required. In the event of a failure, the circular buffer of detailed data (data that was stored just prior to the failure) can be uploaded to the personal computer for analysis by maintenance personnel and engineers. This is the equivalent of having a storage oscilloscope attached to the unit at the moment a failure occurred. Besides having the database of summarized data, detailed data of the last moments of operation (prior to failure) is available.

The amount of information and the detailed level of control provides information on equipment efficiency, productivity, and longevity in the environment in which the equipment is actually used. This information can be used to plan appropriate maintenance or to make changes is equipment or operating practices.

The peripheral information may also be used to help make decisions about power use. If peak power demands are too high, the facility controller (or intelligent relay system) can make decisions on reducing HVAC load based on ambient temperature. Lighting levels can be reduced based on ambient light sensors. Shock and vibration sensors can even be used to locate (in real time) a catastrophic problem m vibrating equipment or an impact point on a military vessel.

While the preferred embodiments have been shown and described, it will be understood that there is no intent to limit the invention by such disclosure, but rather, it is intended to cover all modifications and alternate constructions falling within the spirit and scope of the invention as defined in the appended claims.

1. An intelligent relay system adapted for quickly responding to a variety of influences, comprises:
at least one relay,
at least one peripheral sensor collecting data related to the relay system; and
a control logic section linked to the relay and the sensor, the control logic section is further linked to a control computer via a communication interface;
the control logic section includes means for intelligently controlling operation of the relay based upon instructions received from the control computer and data collected via the at least one peripheral sensor and the relay.

2. The relay system according to claim 1, further including a data collection module in which data generated by the relay and the sensor is collected for use by the control logic section.

3. The relay system according to claim 2, wherein the data collection module includes an analog to digital converter.

4. The relay system according to claim 1, wherein the relay is a solid-state relay.

5. The relay system according to claim 4, wherein the relay is a MOSFET based AC electronic relay.

6. The relay system according to claim 1, wherein the control logic section is includes a microprocessor/control logic.

7. The relay system according to claim 6, wherein the microprocessor/control logic includes means for serial communication.

8. The relay system according to claim 6, wherein the microprocessor/control logic includes switch control logic for controlling operation of the relay.

9. The relay system according to claim 8, wherein the microprocessor/control logic includes means for storing values determining what inputs and what combination of inputs determine an output of the switch control logic.

10. The relay system according to claim 1, wherein the control logic section includes a control input which actuates the relay.

11. The relay system according to claim 10, wherein the control input collects data which is employed by the control logic section in the operation of the relay system.

12. The relay system according to claim 1, wherein data includes power information and effectual information.

13. The relay system according to claim 12, wherein power information includes voltage, current and power factor information.

14. The relay system according to claim 12, wherein effectual information concerns effects of power demands and results of deciding to use or not to use power.

15. The relay system according to claim 1, further including means for data management providing for the identification of trends, problems and anomalies.

16. The relay system according to claim 1, further including means for decision capabilities providing for timely and efficiently decision making.

17. The relay system according to claim 1, further including means for controlling operation of the relay system through the implementation of real time changes in operation.

18. The relay system according to claim 1, further including means for information management.

19. A relay system network composed of a plurality of networked intelligent relay systems adapted for quickly responding to a variety of influences, each of the relay systems comprising:
at least one relay,
at least one peripheral sensor collecting data related to the relay system; and
a control logic section linked to the relay and the sensor, the control logic section is further linked to a control computer via a communication interface;
the control logic section includes means for intelligently controlling operation of the relay based upon instructions received from the control computer and data collected via the at least one peripheral sensor and the relay.

20. The relay system network according to claim 19, wherein the relay systems are configured in a daisy chain configuration.

21. The relay system network according to claim 19, wherein serial communication links link the plurality of relay systems.

22. The relay system network according to claim 21, wherein a single serial communication link links relay systems.

23. The relay system network according to claim 22, wherein multiple serial communication links link coupled relay systems to provide redundant capabilities for a more fault tolerant network.

24. The relay system network according to claim 19, further including a smart load center including means for controlling the plurality of relay systems connected thereto.

25. The relay system network according to claim 19, further including a data collection module in which data generated by the relay and the sensor is collected for use by the control logic section.

26. The relay system network according to claim 25, wherein the data collection module includes an analog to digital converter.

27. The relay system network according to claim 19, wherein the relay is a solid-state relay.

28. The relay system network according to claim 27, wherein the relay is a MOSFET based AC electronic relay.

29. The relay system network according to claim 19, wherein the control logic section is includes a microprocessor/control logic.

30. The relay system network according to claim 29, wherein the microprocessor/control logic includes means for serial communication.

31. The relay system network according to claim 29, wherein the microprocessor/control logic includes switch control logic for controlling operation of the relay.

32. The relay system network according to claim 31, wherein the microprocessor/control logic includes means for storing values determining what inputs and what combination of inputs determine an output of the switch control logic.

33. The relay system network according to claim 19, wherein the control logic section includes a control input which actuates the relay.

34. The relay system network according to claim 33, wherein the control input collects data which is employed by the control logic section in the operation of the relay system.

35. The relay system network according to claim 19, wherein data includes power information and effectual information.

36. The relay system network according to claim 35, wherein power information includes voltage, current and power factor information.

37. The relay system network according to claim 35, wherein effectual information concerns effects of power demands and results of deciding to use or not to use power.

38. The relay system network according to claim 19, further including means for data management providing for the identification of trends, problems and anomalies.

39. The relay system network according to claim 19, further including means for decision capabilities providing for timely and efficiently decision making.

40. The relay system network according to claim 19, further including means for controlling operation of the relay system through the implementation of real time changes in operation.

41. The relay system network according to claim 19, further including means for information management.
